(19) United States
(12) Patent Application Publication
(10) Pub. No.: US 2006/0048885 A1
(43) Pub. Date: Mar. 9, 2006

(54) Method for reproduction of a compnent with a micro-joint and component produced by said method

(75) Inventors: Olivier Constantin, Grenoble (FR); Frederique Mittler, Saint Egreve (FR); Philippe Combette, Montpellier (FR)

Correspondence Address: OLIFF & BERRIDGE, PLC, P.O. BOX 19928, ALEXANDRIA, VA, 22320, US

(73) Assignee: COMMISSARIAT A L'ENERGIE ATOMIQUE, Paris (FR)

(21) Appl. No.: 10/533,296

(22) PCT Filed: Nov. 4, 2003
(86) PCT No.: PCT/FR03/03288

§ 371 Date: Apr. 29, 2005

(51) Int. Cl. B44C 1/165; B32B 37/00; B32B 38/10

(52) U.S. Cl. 156/230; 156/247

(57) ABSTRACT

The method for production of a component with a micro-joint comprises a first step of deposition of a layer of polymer designed to constitute an assembly joint on a transfer substrate, a second step of bringing the polymer layer into contact with a micro-structured substrate and a third step of removing the transfer substrate. Due to the difference of the chemical affinity between the polymer layer and the transfer substrate on the one hand and the chemical affinity between the polymer layer and the micro-structured substrate on the other hand, the zones of the polymer layer, which are in contact with the micro-structured substrate during the second step, remain on the micro-structured substrate after the third step. These zones constitute the assembly joint.

### BACKGROUND OF THE INVENTION

The invention relates to a method for production of a component, comprising a micro-structured substrate and a complementary element assembled by means of an assembly joint. It also relates to a component produced by this method.

### STATE OF THE ART

Production of micro-structured components, in particular micro-fluidic devices (biochips, lab-on-chip, etc.) or micro electro-mechanical devices (MEMS, MOEMS, etc.), generally involves surface or volume micro-structuring of at least one substrate where free spaces are created enabling fluids to circulate or to be stored. The cavities and channels thus created are open on at least one side and therefore have to be connected or assembled to another structure (open or closed cover, capillaries, other micro-fluidic substrate.).

Assembly of micro-structured components requires assembly joints and seals that may be micro-structured. However, handling and positioning of micro-structured joints is very difficult. Techniques exist using in particular Polydimethylsiloxane as assembly joint, with complex methods to define the surface of the joint. Other assembly techniques exist for substrates whose assembly surfaces may be locally very small, but these techniques require high temperatures or chemical preparations limiting the possibility of functionalizing the components to be assembled (for example by biological grafting) and are restrictive in the choice of materials. In the field of polymer assembly, thermal welding also limits the choice of materials. The use of pre-glued adhesive films presents the drawback of the presence of glue in contact with fluids to be handled and gives rise to problems of biological compatibility.

More conventional gluing techniques (glue distribution by syringe, pad printing, glue rollers, screen printing), apart from the problems related to polymerization of liquid glues in the presence of biological species, prove unsuitable for assembly of micro-structures presenting very small assembly surfaces (<20 μm).

Known assembly techniques thus give rise to problems of biological compatibility and/or are complex, which limits the application possibilities. In addition, certain techniques do not enable reversible assembly of two components.

### OBJECT OF THE INVENTION

It is one object of the invention to remedy these drawbacks and, more particularly, to propose a method for production of micro-structured components minimizing the problems of biological compatibility, while reducing the complexity and manufacturing cost.

According to the invention, this object is achieved by the fact that the method comprises fabrication of the assembly joint by:

a first step of deposition of a thin layer of polymer on a transfer substrate, the transfer substrate and the thin polymer layer having a predetermined chemical affinity,

a second step of bringing the micro-structured substrate and the thin polymer layer into contact, the micro-structured substrate and the thin polymer layer having a greater chemical affinity than the chemical affinity between the transfer substrate and the thin polymer layer,

a third step of removing the transfer substrate, so that the assembly joint is formed by the zones of the thin polymer layer coming into contact with the micro-structured substrate in the course of the second step.

According to a preferred embodiment, the transfer substrate is flexible and removal of the transfer substrate is performed by pulling the latter via one end.

According to a development of the invention, the method comprises a step of chemical activation of the complementary element and/or, after the third step, a step of chemical activation of the assembly joint arranged on the micro-structured substrate. An irreversible assembly of the micro-structured substrate and of the complementary element can thus be achieved.

It is another object of the invention to provide a component, produced by the above method, and comprising a complementary element assembled to the micro-structured substrate by the assembly joint, the element being a cover, another micro-structured substrate, a capillary or a matrix of capillaries secured to one another.

### BRIEF DESCRIPTION OF THE DRAWINGS

Other advantages and features will become more clearly apparent from the following description of particular embodiments of the invention given as non-restrictive examples only and represented in the accompanying drawings, in which:

FIGS. 1 to 6 represent different steps of a particular embodiment of a method according to the invention.

FIG. 7 represents a particular embodiment of the invention with bearing zones on the micro-structured substrate.

FIG. 8 represents a particular embodiment of a component according to the invention, wherein the complementary element is a capillary.

FIG. 9 represents an alternative embodiment of a transfer substrate.

### DESCRIPTION OF PARTICULAR EMBODIMENTS

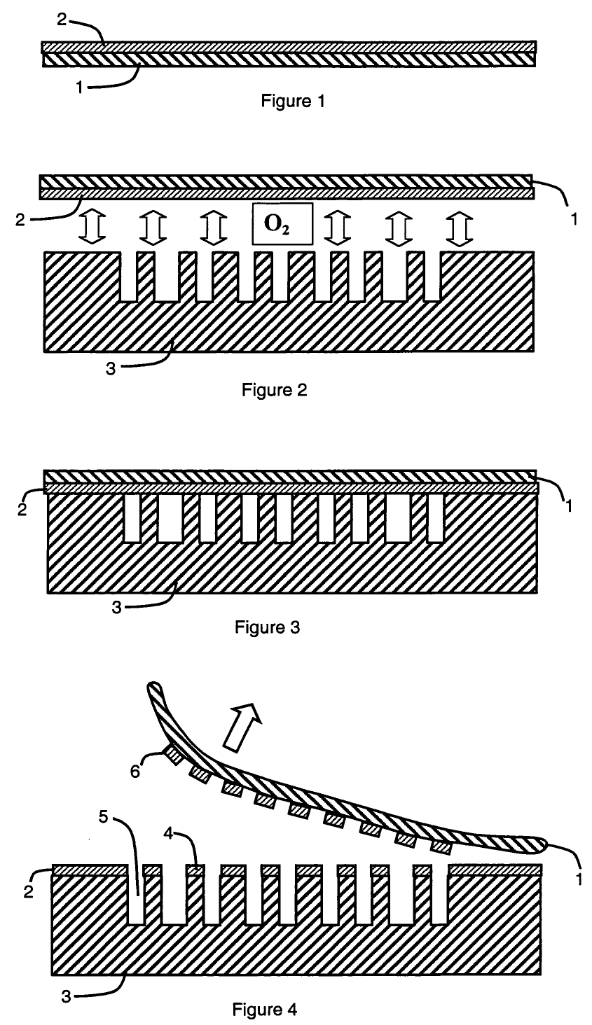

In a first step of the process represented in FIGS. 1 to 6, a thin layer of polymer 2 is deposited on a transfer substrate 1. A typically used deposition technique is spin coating. The polymer of the thin layer 2 and the material of the transfer substrate 1 must have a chemical affinity enabling the second and third steps described hereafter. In a preferred embodiment, the materials of the transfer substrate 1 and of the thin polymer layer 2 are both Polydimethylsiloxane (PDMS). One advantageous property of a PDMS transfer substrate 1 is its flexibility. Depending on the polymer used for the thin layer 2 and on the deposition technique, an additional intermediate cross-linking step, for example by heating, can be added just after deposition.

The second step (FIG. 3) consists in bringing the thin polymer layer 2, supported by the transfer substrate 1, into contact with the micro-structured substrate 3. The chemical affinity between the thin polymer layer 2 and the micro-structured substrate 3 must be greater than the chemical affinity between the thin polymer layer 2 and the transfer substrate 1. Adjustment of the chemical affinity between the thin polymer layer 2 and the micro-structured substrate 3 can be performed, before the second step, by additional intermediate chemical activation steps. As represented in FIG. 2, the chemical activation steps can be applied to the polymer layer 2 and/or to the micro-structured substrate 3. A chemical activation means used is an oxygen plasma. In FIG. 2, simultaneous plasma oxidizing of the thin polymer layer 2 and of the micro-structured substrate 3 is represented. Moreover, the tenacity of the thin polymer layer 2 decreases after the plasma oxidizing, facilitating the third step of the method described below. The thin polymer layer can be irreversibly glued to the micro-structured substrate by suitably adjusting the chemical affinity by chemical activation steps before the second step (FIG. 2).

In a third step, the transfer substrate 1 is removed. Only the zones of the thin polymer layer 2 in contact with the micro-structured substrate 3 during the second step remain on the micro-structured substrate 3. As the chemical affinity between the micro-structured substrate 3 and the thin polymer layer 2 is greater than the chemical affinity between the thin polymer layer and the transfer substrate 1, the thin polymer layer 2 in fact tears, a part 4 remaining fixed to the micro-structured substrate 3, the rest 6 being removed with the transfer substrate 1. The zones of the thin polymer layer 2 that were not in contact with the micro-structured substrate 3 during the second step thus remain as residues 6 on the transfer substrate 1. The assembly joint 4 is thus formed by the zones of the thin polymer layer 2 remaining on the micro-structured substrate 3. In the case of a flat transfer substrate 1, the second step does not require any alignment, the micro-structured substrate 3 itself defining the contact zones with the thin polymer layer 2. For the thin polymer layer to tear at the edge of the patterns machined in the micro-structured substrate 3, the tenacity of the thin polymer layer 2 must be very weak. The tenacity can be reduced in particular by plasma oxidizing prior to the second step (FIG. 2).

The method described above enables an assembly joint 4 to be formed having the same shape as the micro-structured substrate 3 to be connected or assembled, without leaving any dead volume and without adding any matter above cavities 5 formed in the micro-structured substrate 3. The surface of the assembly joint 4 in contact with the materials (fluids, liquids, etc.) contained in the cavities 5 is therefore minimized, which enables a possible interaction between the material of the assembly joint 4 and the materials contained in the cavities 5 to be attenuated. The biological compatibility of the component is thus optimized.

This method enables a multitude of micro-assembly joints to be formed simultaneously, each joint being able to be very small (<20 μm), on micro-structured substrates of large surface (treatment of a complete wafer), the micro-structured substrate itself confining the assembly joint. The method is quick, inexpensive and does not require any alignment for formation of the joints.

In a preferred embodiment, execution of the third step is facilitated by the use of a flexible transfer substrate that can be removed via one end (FIG. 4). This makes it possible to avoid using too great a force that might damage the component.

After the third step, a complementary element 7 can be fixed onto the micro-structured substrate 3 by means of the assembly joint 4, possibly in reversible manner, securing the complementary element 7 by means of a device (not shown) ensuring an intimate contact with the assembly joint 4. It is also possible to fix the complementary element 7 in irreversible manner on the micro-structured substrate 3 by adding one or more chemical activation steps of the assembly joint 4 and/or of the complementary element 7, for example by plasma oxidizing (FIG. 5). A component obtained in this way, comprising a micro-structured substrate 3 and a complementary element 7 assembled by means of an assembly joint 4, is represented in FIG. 6.

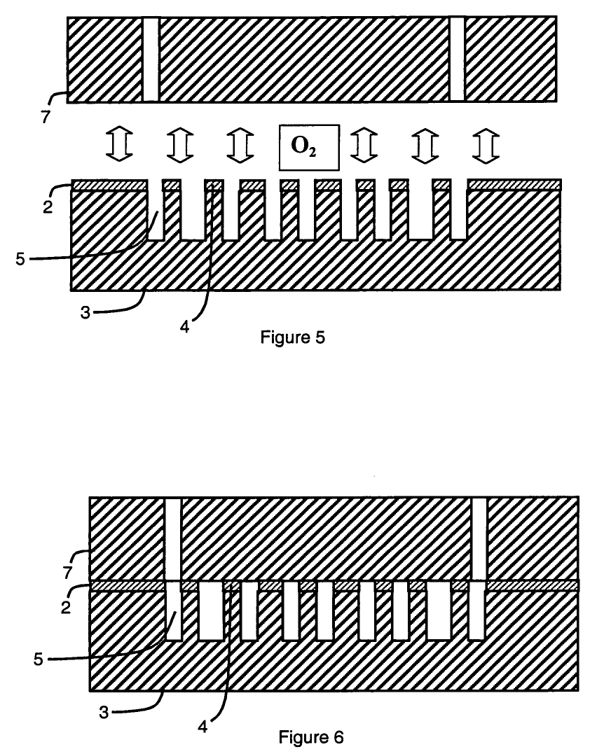

In a particular embodiment, represented in FIG. 7, the micro-structured substrate 3 comprises a bearing zone 8 acting as bearing surface for the transfer substrate 1 in the course of the second step in the case where zones designed to define the assembly joint 4 are located relatively distant from one another. The bearing zones 8 thus prevent the thin polymer layer 2 from sticking on the bottom surfaces 9 of the micro-structured substrate 3 comprised between two zones defining the assembly joint, while ensuring the parallelism between the transfer substrate and the micro-structured substrate during the second step.

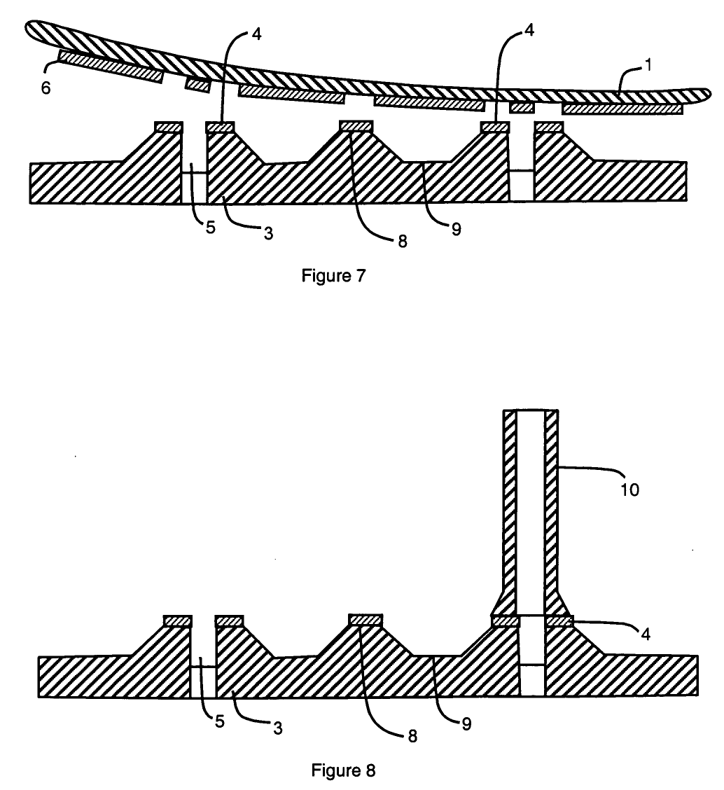

In the alternative embodiment represented in FIG. 6, the complementary element 7 is a cover 7 closing the cavities 5 of the micro-structured substrate 3. According to another particular embodiment of the invention, represented in FIG. 8, the complementary element is formed by a capillary 10 or a matrix of capillaries secured to one another. In another embodiment, the complementary element 7 is another micro-structured substrate.

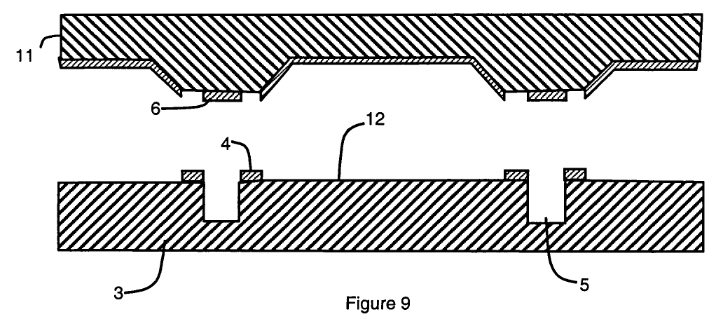

In a particular embodiment, represented in FIG. 9, the transfer substrate is a micro-structured substrate 11 enabling contact of the thin polymer layer 2 to be prevented on certain zones 12 of the surface of the micro-structured substrate 3. Formation of a micro-structured transfer substrate 11 of this kind can be achieved by molding for example. However, unlike a flat transfer substrate, a micro-structured transfer substrate 11 requires an alignment with the micro-structured substrate 3 during the second step of the method, making the method more complicated.

The material of the assembly joint is to be chosen from among thermo-hard resins, elastomers or elastomer thermoplastics meeting the following criteria:
being sufficiently flexible once the joint is formed to perform its tightness and assembly function, enabling for example roughness or flatness defects of the micro-structured substrate to be compensated (visco-elastic behavior),
forming covalent bonds with the micro-structured substrate and the transfer substrate, after suitable treatment if required,
having a low tenacity, after suitable treatment if required, so as to tear easily when transfer takes place. The above-mentioned polymer families see their tenacity decrease over a depth generally of 100 μm to 150 μm after plasma oxidizing. As the thickness range of the joint described is smaller, it will be oxidized and therefore made fragile over its whole depth, thus rendering the transfer operation easier,
preferably, being available in liquid form to be able to be spread by spin coating.

Polydimethylsiloxane (PDMS), and more particularly Sylgard® 184 grade from Dow Corning®, is particularly suitable, notably on account of its optic and biological compatibility qualities. Dow Corning® Sylgard® 184 grade PDMS can be activated by a low-energy oxygen plasma (creation of SiOH and OH sites; hydroxylation) enabling it to be irreversibly stuck to silicon, to glass, to a wide range of plastics, to itself, etc. It is available in non cross-linked form, supplied along with a hardener, and therefore sufficiently liquid to be spread by spin coating. Surface hydroxylation could be performed by plunging the selected polymer into boiling water. This method does however prove less simple to implement.

The transfer substrate material is preferably chosen to be able to form covalent bonds (free methacryl groups for example, which bond with the methacryl groups of the thin layer PDMS) with the assembly joint material and for its flexibility. For this reason, a preferable choice is a transfer substrate made from PDMS, freshly fabricated to avoid any problem of dust collection related to storage, as PDMS is very fond of dust.

The thin layer of PDMS is preferably hot cross-linked to save time (4 hours at 60°). The use of a spin-coating-whirler enables the thickness of the assembly joint to be chosen (typically between a few micrometers and 50 μm).

The material of the micro-structured substrate to be assembled or connected, or at least of the surfaces dedicated to formation of the assembly joint, must be able to be activated to form covalent bonds with said assembly joint. Likewise, covalent bonds can be achieved between said joint and the complementary element. Under these conditions, the assembled final component can be fluid-tight.

In fabrication of enzymatic digestion reactors on silicon, the micro-structured substrate is composed of channels with a length of several millimeters and a width of 1 mm wherein matrices of columns with a diameter of 5 μm or 10 μm are micro-machined (several million columns). This enables the surface/volume ratio of said reactors to be increased, the enzymatic digestion reaction taking place between enzymes grafted on the walls and proteins conveyed in these reactors.

The present invention, as described above, has notably enabled an assembly joint to be formed on very small patterns (square columns with 5 μm sides and hexagonal columns with a diameter of 10 μm), and on relatively large surface components (4×2 cm²), without any dead volume above these columns, while minimizing the surface of PDMS facing the fluids (problems of protein adsorption on the PDMS).

1-16. (canceled)

17. Method for production of a component, comprising a micro-structured substrate and a complementary element assembled by means of an assembly joint, method comprising fabrication of the assembly joint by:
a first step of deposition of a thin layer of polymer on a transfer substrate,
a second step of bringing the micro-structured substrate and the thin polymer layer into contact,
a third step of removing the transfer substrate so that the assembly joint is formed by the zones of the thin polymer layer coming into contact with the micro-structured substrate in the course of the second step,
method wherein the transfer substrate is flexible and removal of the transfer substrate is performed by pulling the latter via one end, the micro-structured substrate and the thin polymer layer having a greater chemical affinity than the chemical affinity between the transfer substrate and the thin polymer layer.

18. Method for production according to claim 17, comprising a cross-linking step of the thin polymer layer between the first and second steps.

19. Method for production according to claim 17, comprising a chemical activation step of the thin polymer layer deposited on the transfer substrate between the first and second steps.

20. Method for production according to claim 17, comprising a chemical activation step of the micro-structured substrate between the first and second steps.

21. Method according to claim 17, wherein the transfer substrate is made from Polydimethylsiloxane (PDMS).

22. Method according to claim 17, comprising, after the third step, a chemical activation step of the assembly joint arranged on the micro-structured substrate.

23. Method according to claim 17, comprising a chemical activation step of the complementary element.

24. Method according to claim 17, wherein the micro-structured substrate comprises at least one bearing zone acting as support for the transfer substrate in the course of the second step.

25. Method according to claim 17, wherein the transfer substrate is flat.

26. Method according to claim 17, wherein the transfer substrate is micro-structured.

27. Method according to claim 17, wherein the polymer material of the thin polymer layer is chosen from among thermo-hard resins, elastomers and elastomer thermoplastics.

28. Method according to claim 27, wherein the polymer material of the thin polymer layer is Polydimethylsiloxane (PDMS).

29. Component, produced by the method according to claim 17, wherein the complementary element is a cover.

30. Component, produced by the method according to claim 17, wherein the complementary element is another micro-structured substrate.

31. Component, produced by the method according to claim 17, wherein the complementary element is a capillary or a matrix of capillaries secured to one another.
